(19) United States
(12) Patent Application Publication
(10) Pub. No.: US 2020/0026688 A1
(43) Pub. Date: Jan. 23, 2020

(54) FILE SHARING METHOD BASED ON TWO-DIMENSIONAL CODE, SERVER AND TERMINAL DEVICE

(71) Applicant: SOUTH UNIVERSITY OF SCIENCE AND TECHNOLOGY, Shenzhen, Guangdong (CN)

(72) Inventors: Manhong YUNG, Shenzhen, Guangdong (CN); Zhensheng ZHANG, Shenzhen, Guangdong (CN); Yanfeng LI, Shenzhen, Guangdong (CN)

(21) Appl. No.: 16/073,085

(22) PCT Filed: May 25, 2018
(86) PCT No.: PCT/CN2018/088398

§ 371 Date: Jul. 26, 2018

(30) Foreign Application Priority Data
Mar. 16, 2018 (CN) 201810220405.4

(51) Int. Cl. G06F 16/176; G06K 19/06; H04L 29/08; H04L 12/58

(52) U.S. Cl. CPC G06F 16/176; G06K 19/06037; H04L 67/42; H04L 51/22; H04L 51/28; H04L 67/06

(57) ABSTRACT

The present application relates to the technical field of data processing, providing a file sharing method based on two-dimensional code, a server, a terminal device and a computer readable storage medium. The method comprising: obtaining a user mail sent by a user, wherein the user mail contains a mail subject, a user address and a shared file; storing the shared file and obtaining a storage address; generating a two-dimensional code corresponding to the storage address; returning the two-dimensional code to the user, wherein the two-dimensional code serves as an access entry of the shared file and is used for accessing the shared file by the user. The embodiments of the present application simplify the operational process of file sharing and improve the processing efficiency of file sharing.

### FIELD OF THE PRESENT APPLICATION

The present application relates to the technical field of data processing, and particularly relates to a file sharing method based on a two-dimensional code, a server, a terminal device and a computer readable storage medium.

### The Related Art

With the development of internet technology, file sharing has become a hot demand for computer users. The file sharing can be implemented based on a client/server architecture and a browser/server architecture. In the client/server architecture, a certain computer serving for a client needs to establish connection with the port of a server and implement file uploading. Other computers could access the files through accessing the server, so that file sharing is achieved. In the browser/server architecture, users mainly upload files through the browser of a computer, other user access and download the files through the browser.

However, in the existing file sharing methods, if the file sharing method is based on a client/server architecture, the client is required to be installed and establish a connection with the server. For ordinary users, the applicability thereof is low. If the file sharing method is based on a browser/server architecture, the file sharing is implemented through a shared website. Although there is no need to install the client, the shared website needs to be logged in when files are uploaded or downloaded, and for each access the domain name of the website is needed to be enter in the browser, thus the way of operation is dull. In conclusion, the existing file sharing methods are relatively complicated in operation and processing efficiency of the file sharing is low.

### SUMMARY

In view of the above-mentioned problems, the embodiments of the present application provides a file sharing method based on a two-dimensional code, a server, a terminal device and a computer readable storage medium, so as to solve the problems in the prior art that relevant operations of the file sharing are complicated and processing efficiency is low.

The first aspect of embodiments of the present application provides a file sharing method based on two-dimensional code, comprising:

obtaining a user mail sent by a user, wherein the user mail contains a mail subject, a user address and a shared file;

storing the shared file and obtaining a storage address;

generating a two-dimensional code corresponding to the storage address; and

returning the two-dimensional code to the user, wherein the two-dimensional code serves as an access entry of the shared file and is used for accessing the shared file by the user.

The second aspect of embodiments of the present application provides a server, the server comprising:

an obtaining unit configured for obtaining a user mail sent by a user, wherein the user mail contains a mail object, a user address and a shared file;

a storage unit configured for storing the shared file and obtaining a storage address;

a generation unit configured for generating a two-dimensional code corresponding to the storage address; and

a return unit configured for returning the two-dimensional code to the user, wherein the two-dimensional code serves as an access entry of the shared file and is used for accessing the shared file by the user.

The third aspect of embodiments of the present application provides a terminal device, comprising a processor, a storage, a computer program stored in the storage and capable of running in the processor, wherein the processor implements the steps of the above-mentioned file sharing method when executing the computer program.

The forth aspect of embodiments of the present application provides a computer readable storage medium, the computer readable storage medium storing a computer program, wherein the computer program implements the steps of the above-mentioned file sharing method when the computer program is executed by a processor.

Compared with the prior art, the embodiment of the present application has the following advantageous effects:

According to the embodiments of the present application, through obtaining the user mail sent by the user, wherein the user mail contains the mail object, the user address, the shared file and the like; then storing the shared file contained in the user mail, obtaining a storage address; and generating a two-dimensional code corresponding to the storage address; finally returning the two-dimensional code to the user sending the user mail, such that the user could access the storage address through the two-dimensional code so as to access the shared file. The file sharing operations are simplified, and the processing efficiency is improved.

### BRIEF DESCRIPTION OF THE DRAWINGS

In order to illustrate the technical solutions provided by the embodiments of the present application more clearly, drawings required to be used in the description of the embodiments or in the prior art will be introduced briefly hereinafter. Obviously, the drawings in the following description are only for some embodiments of the present application. For those ordinary skilled in the art, other drawings can be obtained according to the drawings provided herein without creative efforts.

FIG. 1 is an implementation flow diagram of a file sharing method based on two-dimensional code according to an embodiment I of the present application;

FIG. 2 is an implementation flow diagram of the file sharing method based on two-dimensional code according to an embodiment II of the present application;

FIG. 3 is an implementation flow diagram of the file sharing method based on two-dimensional code according to an embodiment III of the present application;

FIG. 4 is an implementation flow diagram of the file sharing method based on two-dimensional code according to an embodiment IV of the present application;

FIG. 5 is an implementation flow diagram of the file sharing method based on two-dimensional code according to an embodiment V of the present application;

FIG. 6 is a structural block diagram of a server according to an embodiment VI of the present application;

FIG. 7 is a schematic diagram of a terminal device according to an embodiment VII of the present application.

### DETAILED DESCRIPTION OF THE ENABLING EMBODIMENTS

In the following description, for purposes of illustration but not limitation, specific details are provided, such as particular system structure, technology and the like, so that embodiments of the present application can be thorough understood. However, those skilled in the art should understand that the present application can also be implemented in other embodiments without these specific details. In other cases, detailed descriptions of well-known systems, devices, circuits and methods are omitted, so as not to obscure the description of the present application with unnecessary details.

In order to illustrate the technical solution of the present application, specific embodiments are described as follows:

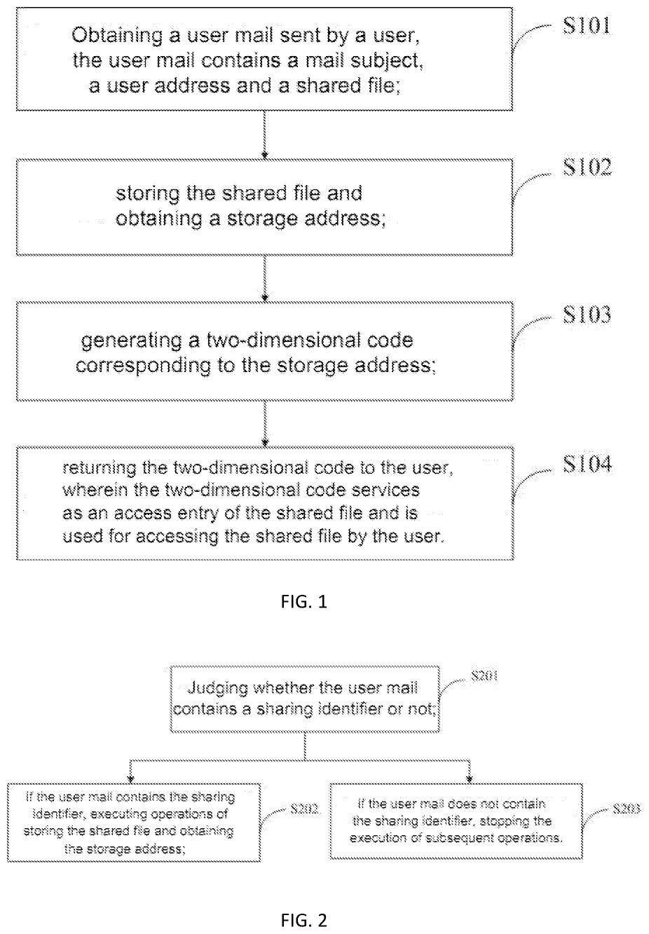

FIG. 1 shows the implementation process of a file sharing method based on two-dimensional code provided by an embodiment of the present application, which is described in detail as follows:

In S101, obtaining a user mail sent by a user, wherein the user mail contains a mail subject, a user address and a shared file.

In the embodiment of the present application, the file sharing is realized mainly through a two-dimensional code. Firstly, a user performs configurations for a user mail in a user mailbox. In general, the user mail contains a mail subject, a user address (namely the mail address of the user mailbox), a shared file (in the form of an attachment carried in the user mail), a receiver address (the address to which the user mail is sent), mail contents and the like. Wherein the receiver address is configured to be an mail address of a designated mailbox, so that after the designated mailbox receives the user mail sent by the user, a server corresponding to the designated mailbox identifies the user's intention and implements subsequent operations on the shared file in the user mail. After the configurations are completed, the user performs the operation of sending the user mail, so that the designated mailbox receives the user mail. It is noted that during the configuration process of the user mail, the devices used by the user is not limited, namely the user is allowed to use a device supporting the mailbox, such as a computer, a mobile phone, a tablet computer or the like that to perform the configurations of the user mail.

Optionally, a mail template is configured in advance. Due to the fact that there are not many contents that need to be configured in the user mail sent by the user, and the main content that needs to be configured is the shared file attached in the user mail. Other contents such as the user address and the receiver address generally are regular contents, so said other contents can be configured in advance and the mail template is generated. The user only needs to upload the shared file, so that the user mail can be automatically generated based on the mail template. On the basis of above mentioned, optionally, after the user mail is generated, automatically sending is implemented. According to the method described above, traditional file sharing implemented via a shared website can be replaced. The time used for accessing a shared website and logging in the shared website by a user can be saved, and the efficiency of sending a mail can be improved.

In S102, storing the shared file and obtaining storage address.

After the designated mailbox receives the user mail, the server of the designated mailbox extracts the shared file from the attachments of the user mail, and the storage space is allocated in the database so as to store the shared file, wherein the database can be a SQL Server database, an Oracle database or a MYSQL database and the like. In addition, in order to facilitate the classification, storage can be realized based on a distributed database, wherein different databases store different file types of a shared file.

Optionally, on the basis of implementation of storing the shared file in the user mail, the mail contents are further stored. In some application scenarios, the mail contents may also be one of the contents that the user wishes to share in the file sharing. For example, a teacher wants to share course assignments through a mail, and an attachment of the course assignments is added to the user mail to serve as the shared file, and relevant requirements of the course assignments are also added in the mail contents, so in the demand of the teacher, the mail contents is also one of the contents that needs to be shared. Therefore in the embodiment of the present application, after the server of the designated mailbox receives the user mail, the shared file and the mail contents of the user mail are extracted. The shared file and the mail contents are packaged and stored, with the storage address thereof in the database generated.

In S103, generating a two-dimensional code corresponding to the storage address.

After the server of the designated mailbox finishes storing the shared file, the access approach of the shared file needs to be provided to the user. In the embodiment of the present application, the two-dimensional code corresponding to the storage address of the shared file in a database is generated. Wherein the two-dimensional code is a black-white inter-crossed pattern which is formed by certain specific geometric figures distributed (in two-dimensional direction) on a plane according to certain rules and the pattern is used for recording specific information. The two-dimensional code can be a Quick Response code (QR code). Due to the fact that the information stored in the two-dimensional code is limited, the shared file cannot be directly stored, instead the corresponding storage address is stored.

In S104, returning the two-dimensional code to the user, wherein the two-dimensional code serves as an access entry of the shared file and is used for accessing the shared file by the user.

After the two-dimensional code is generated, the server of the designated mailbox returns the two-dimensional code to the user, wherein the return mode is preset. For example, after the two-dimensional code is generated, the server sends the two-dimensional code to the user through a message or an instant messaging software or the like. Of course, the more convenient and simpler method is to return the two-dimensional code to the user through a mail, the specific details are set forth in the following contents.

According to the embodiment shown in FIG. 1, in the embodiment of the present application, obtaining the user configurations and sending the user mail through a designated mailbox, wherein the user mail contains the mail subject, the user address, a shared file and the like. The server of the designated mailbox allocates a storage space for the shared file in the database, and the storage address is obtained after the shared file are stored. The two-dimensional code corresponding to the storage address is generated, and finally the two-dimensional code is returned to the user, so that the user conveniently accesses and downloads the shared file through the two-dimensional code. The user does not need to log in the shared website or install the client and other operations alike and the processing efficiency of the file sharing is improved. In addition, after the user obtains the two-dimensional code, the two-dimensional code can be simply shared to others, so that the sharing effect of the file sharing is improved.

As shown in FIG. 2, on the basis of embodiment I of the present application, after the designated mailbox receives the user mail sent by the user, a process of implementing judgments on user mail is added. The flow diagram of the implementation of the file sharing method based on two-dimensional code according to an embodiment of the present application, as shown in the drawing, the file sharing method includes the following steps:

In S201, judging whether the user mail contains a sharing identifier or not.

When the user configures the user mail, the purpose of the user may be not to implement the file sharing, but to implement mail archiving or other operations. Therefore, a sharing mechanism is set, wherein after the designated mailbox receives the user mail sent by the user, the server of the designated mailbox extracts the contents of the user mail and analyzes the contents, judging whether the user mail contains the sharing identifier or not, and executing different operations according to the judgment result. For example, to set the sharing identifier is to include a field of “shared” in the mail. If the user intends to share a file, a field of “shared” is added to the user mail when the mail is configured. Thus, the server of the designated mailbox implements field identification after receiving the user mail, and judging whether the user mail contains the sharing identifier or not. Preferably, judging whether the mail subject includes the sharing identifier or not, and executing different operations according to the judgment result. Due to the fact that analyzing the field extracted from the mail subject is relatively convenient, so setting the judgment of whether the sharing identifier is contained in the mail subject, which can standardize the process of judgment, and the judgment accuracy can be improved.

In S202, if the user mail contains the sharing identifier, executing operations of storing the shared file and obtaining the storage address.

If it is determined that the user mail sent by the user contains the sharing identifier, it is proved that the user mail is a file that needs to be implemented the file sharing. Then the server of the designated mailbox implements storing of the shared file and subsequent operations, such as obtaining the storage address.

In S203, if the user mail does not contain the sharing identifier, stopping the execution of subsequent operations.

If it is determined that the user mail sent by the user does not contain the sharing identifier, it is proved that the mail is sent based on other intentions of the user, so that the server of the designated mailbox stops executing subsequent operations related to file sharing. Optionally, more mechanisms similar to said sharing mechanism are set, so that the server of the designated mailbox could complete more functions. For example, setting an archiving mechanism, when the server of the designated mailbox receives the user mail sent by the user containing the “archived” field, the files in the user mail are stored in a database; setting an extracting mechanism, when the server of the designated mailbox receives the mail containing the “extraction” field sent by the user, the file corresponding to the user mail in the database is extracted, the setting of the mechanism can be deduced by analogy, and the description thereof is not repeated herein.

Through the embodiment shown in FIG. 2, it is known that in the embodiment of the present application, through the server of the designated mailbox, judging whether the user mail sent by the user contains the sharing identifier or not, and if it is determined that the user mail contains the sharing identifier, executing the operations of storing the shared file contained in the mail and obtaining the storage address; If it is determined that the user mail does not include the sharing identifier, stop executing the subsequent operations. The user intention is fully considered, and the accuracy of executing file sharing operations is improved.

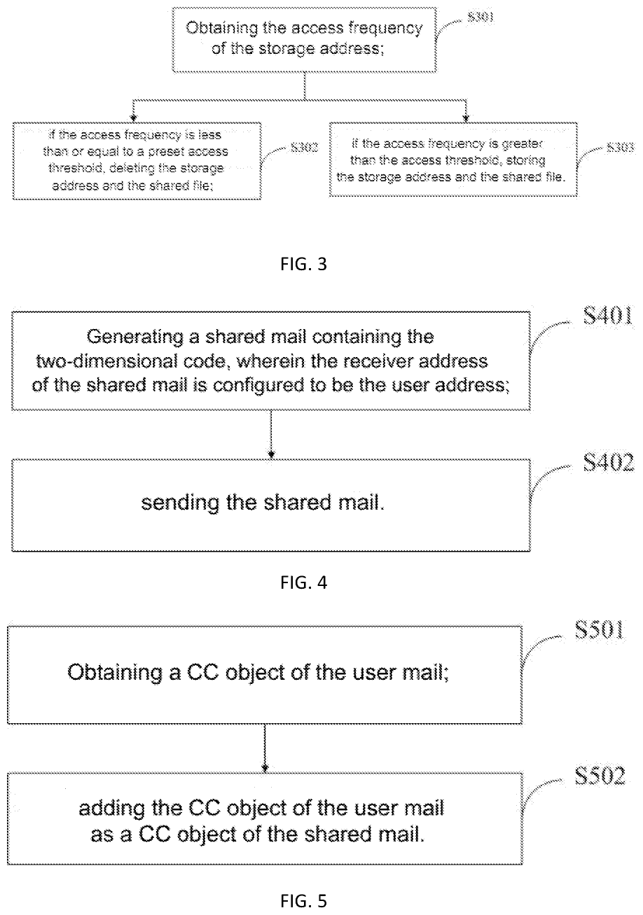

As shown in FIG. 3, on the basis of the embodiment I of the present application, after the shared file is stored, obtaining the access frequency of the storage address of the shared file is added, moreover adding a process of deleting or storing operation on the storage address and the shared file. The flow diagram of the file sharing method based on the two-dimension code provided by the embodiment of the present application, as shown in the drawing, the file sharing method comprises the following steps:

In S301, obtaining the access frequency of the storage address.

After the server of the designated mailbox finishes the storing of the shared file contained in the user mail, the storage address of the shared file in the database is obtained, and the user or others access and download the shared file through accessing the storage address. Therefore, in the embodiment of the present application, the access frequency of the shared file is obtained through obtaining the access frequency of the storage address. Specifically, after the storage address is generated, the count value is cleared, and during the preset counting time, if the device accesses the shared file through the storage address, the counting value is increased by one. When the counting time is over, the counting value in the period of the counting time is divided by the counting time, so that the access frequency can be obtained. It should be noted that the process of recording the access frequency of the storage address is generally implemented in real time. When the counting time of a certain period is over, the counting of the next period of counting time is started, wherein the counting value is subjected to zero clearing operation, (when the access frequency is subsequently calculated, directly dividing the counting value by the counting time), or directly counting on the basis of the counting value of the last period of counting time. (when the access frequency is subsequently calculated, subtracting the counting value of the last period of counting time from the counting value of the whole period of counting time, and then dividing the result counting value by the counting time of this period of time.)

In S302, if the access frequency is less than or equal to a preset access threshold, deleting the storage address and the shared file.

After the access frequency of the storage address is calculated, the access frequency value is compared with the preset access threshold value. If the access frequency value is less than or equal to the access threshold value, it is proved that the shared file is not frequently accessed and downloaded by people. In order to save the storage space of the database, deleting the shared file in the database and the corresponding storage address at the same time, after the deletion is completed, the two-dimensional code corresponding to the storage address is invalid. Optionally, after the storage address and the shared file are deleted, the deletion result is returned to the user by means of sending the mail and the like, so that the user conveniently know the deletion situation and the invalid situation of the two-dimensional code. Optionally, the access threshold value is generally set to be zero, that is, within a certain period of time, such as one month, if the storage address is not accessed by devices, the storage address and the shared file are deleted.

In S303, if the access frequency is greater than the access threshold, storing the storage address and the shared file.

If the access frequency value is greater than the access threshold value, the storage address and the shared file are continuously stored, and the corresponding two-dimensional code is naturally valid. Until the access frequency value of a certain period of time is smaller than or equal to the access threshold value, the storage address and the shared file are deleted.

According to the embodiment shown in FIG. 3, in the embodiment of the present invention, obtaining the access frequency of the storage address of the shared file, and comparing the access frequency value with the preset access threshold value, if the access frequency value is smaller than or equal to the access threshold value, deleting the shared file from the database, and deleting the corresponding storage address; If the access frequency value is smaller than the access threshold value, the storage address and the shared file are continuously stored. According to the access situation of the storage address to implement the delete operation or store operation, the storage pressure of the database is relieved.

FIG. 4 shows that on the basis of embodiment I of the present invention, a specific process is obtained through detailing the process of returning the two-dimensional code to the user. An implementation flow diagram of the file sharing method based on the two-dimension code provided by a embodiment of the present application, as shown in the figure, the file sharing method comprises the following steps:

In S401, generating a shared mail containing the two-dimensional code, wherein the receiver address of the shared mail is configured to be the user address.

Due to the fact that the user stores the shared file through sending the user mail, after the server of the designated mailbox generates the two-dimensional code according to the user mail, the two-dimensional code is returned to the user through a mail. Specifically, after the server of the designated mailbox receives the user mail sent by the user, obtaining and storing the user address of the user mail, after the two-dimensional code is generated, a corresponding relationship is established between the two-dimensional code and the user address. Next, the server of the designated mailbox generates a shared mail, wherein the shared mail contains the two-dimensional code, and the user address of the user mail sent by the user serves as the receiver address of the shared mail, and the server is configured for sending the shared mail, optionally, the shared mail template is established in advance, and after the server of the designated mailbox receives the user mail, extracting the user address in the user mail, adding the user address into the shared mail template, and after the server generates the two-dimensional code, and the two-dimensional code is directly added into the mail content or the attachment of the shared mail template, the shared mail is generated and sent, so that the generation operation of the shared mail is simplified, and the generation efficiency is improved.

On the basis of S401, a process of generating a carbon copy object (CC object) for the shared mailbox is added, as shown in FIG. 5, the process comprises the following steps:

In S501, obtaining a CC object of the user mail.

When the user configures the user mail, on the basis that the receiver address of the user mail serves as the designated mailbox, the CC object is configured in the user mail, the user mail is sent to the designated mailbox and the CC object mailbox at the same time. Therefore, in the embodiment of the present application, after the server of the designated mailbox receives the user mail sent by the user, the CC object of the user mail is obtained, and implementing the subsequent process. Wherein, the number of the CC objects is one or more than one.

In S502, adding the CC object of the user mail as a CC object of the shared mail.

After the obtaining is completed, on the basis that the server of the designated mailbox is configured the receiver address of the shared mail to be the user address of the user mail sent by the user, the CC object of the shared mail is configured to be the CC object of the user mail sent by the user, so that the shared mail is sent to the CC object mailbox at the same time, and the CC object is shared with the two-dimensional code.

After the shared mail is generated, in S402 the shared mail is sent.

After the shared mail is generated, the shared mail is sent by the server. Optionally, a send-delay time is preset, configuring that the server immediately sends the shared mail after the shared mail is generated or sends the shared mail after the send-delay time passed, so that the applicability of the shared mail sending is improved.

According to the embodiment shown in FIG. 4, in the embodiment of the present application, a shared mail containing the two-dimensional code is generated through a server of the designated mailbox, and the receiver address of the shared mail is configured to be the user address of the user mail, and the shared mail is sent by the server of the designated mailbox. The user conveniently receives the two-dimensional code through the shared mail, and other sharings are carried out through the two-dimensional code, so that the applicability of file sharing is improved.

It should be understood that the sequence of the serial numbers of the above-mentioned steps in the embodiments is not meant to be the execution sequence, and the execution sequence of each step should be determined according to the function and the internal logic of the steps, the implementation process of the embodiments of the present application should not be limited herewith.

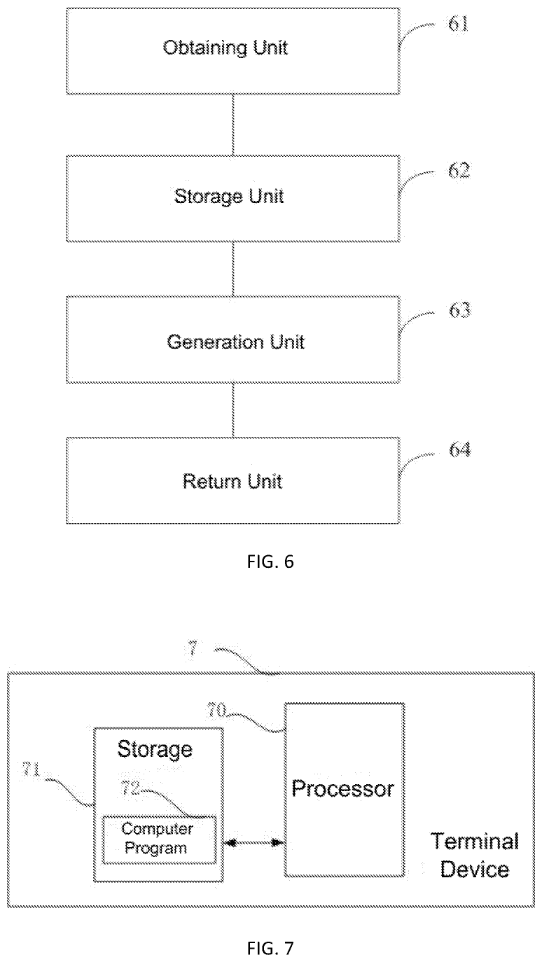

According to the file sharing method based on the two-dimensional code provided by the above-mentioned embodiments, FIG. 6 shows a structural block diagram of a server provided by an embodiment of the present application, referring to FIG. 6, the server comprises:

an obtaining unit 61 configured for obtaining a user mail sent by a user, wherein the user mail includes a mail object, a user address and a shared file;

a storage unit 62 configured for storing the shared file and obtain a storage address;

a generation unit 63 configured for generating a two-dimensional code corresponding to the storage address; and

a return unit 64 configured for returning the two-dimensional code to the user, wherein the two-dimensional code serves as an access entry of the shared file and is used for accessing the shared file by the user.

Optionally, the obtaining unit 61 includes:

a judging unit configured for judging whether the user mail contains a sharing identifier or not;

an execution unit configured for executing operations of storing the shared file and obtaining the storage address, if the user mail contains the sharing identifier; and

a stopping unit configured for stopping the execution of subsequent operations, if the user mail does not contain the sharing identifier.

Optionally, the server further includes:

a frequency obtaining unit configured for obtaining the access frequency of the storage address;

wherein, if the access frequency is less than or equal to a preset access threshold, the storage address and the shared file is deleted;

wherein, if the access frequency is greater than the access threshold, the storage address and the shared file are stored.

Optionally, the return unit 64 includes:

a mail generating unit configured for generating a shared mail containing the two-dimensional code, wherein the receiver address of the shared mail is configured to be the user address; and

a sending unit configured for sending the shared mail.

Optionally, the mail generating unit further includes:

an object obtaining unit configured for obtaining a CC object of the user mail; and

an adding unit configured for adding the CC object of the user mail to be a CC object of the shared mail.

FIG. 7 is a schematic diagram of the terminal device provided by an embodiment of the present application. As shown in FIG. 7, the terminal device 7 provided by the embodiment includes: a processor 70, a memory 71, and a computer program 72 stored in the memory 71, wherein the computer program 72 is capable of running in the processor 70. The processor 70 implements the steps of the file sharing method provided by each of the above-mentioned embodiments, such as the S101 to S104 shown in FIG. 1, when executing the computer program 72. Alternatively, the processor 60 implements the functions of each unit in the server provided by each of the above-mentioned embodiments, such as the functions of the unit 61 to unit 64 shown in FIG. 6, when executing the computer program 62.

Exemplarily, the computer program 72 may be divided into one or more units. The one or more units are stored in the memory 71 and are executed by the processor 70 to implement the present application. The one or more units may be a series of computer program instruction segments capable of implementing a particular function, wherein the instruction segments are configured for describing the execution process of the computer program 72 in the terminal device 7. For example, the computer program 62 may be divided into an obtaining unit, a storage unit, a generation unit and a return unit, wherein each unit has the following specific functions:

an obtaining unit configured for obtaining a user mail sent by a user, wherein the user mail contains a mail object, a user address and a shared file;

a storage unit configured for storing the shared file and obtaining a storage address;

a generation unit configured for generating a two-dimensional code corresponding to the storage address;

a return unit configured for returning the two-dimensional code to the user, wherein the two-dimensional code serves as an access entry of the shared file and is used for accessing the shared file by the user.

The terminal device 7 can be a traditional computer, a notebook computer, a palm computer, a cloud server or other computing devices. The terminal device 7 includes, but is not limited to, the processor 70, the memory 71. Those skilled in the art could understand that FIG. 7 shows only an example of the terminal device 7, and is not a limitation to the terminal device 7. On the basis of FIG. 7, more or fewer units can be included, or some certain units can be combined, or different units. For example, the terminal device 7 could further include input/output device, network access device, a bus and the like.

The processor 70 can be a central processing unit (CPU), or other general purpose processors, a digital signal processor (DSP), an application specific integrated circuit (ASIC)), a field-programmable gate array (FPGA)) or other programmable logic devices, discrete gate or transistor logic devices, discrete hardware components and the like. The general purpose processor can be a microprocessor or any conventional processor or the like.

The storage 71 can be an internal storage unit of the terminal device 7, such as a hard disk or a memory of the terminal device 7. The storage 71 can also be an external storage device of the terminal device 7, such as a plug-in type hard disk, a smart media card (SMC), a secure digital (SD) card, a flash card or the like, which is equipped to the terminal device 7. Further, the storage 71 could also include both the internal storage unit of the terminal device 7 and the external storage device. The storage 71 is configured for storing the computer program and other programs and data needed by the terminal device 7. The storage 71 can also be configured for temporarily storing data that has been output or to be output.

Those skilled in the art would clearly understand that for the convenience and concise of the description, the division of all the functional units mentioned above is only used for illustration. In practical application, the function can be completed by allocating it to different functional units as needs, that is, the internal structure of the server is divided into different functional units so as to complete all or part of the functions described above. The functional units in the embodiments can be integrated in one processing unit, or each of the units can be physically present separately, or two or more than two units can be integrated in one unit. The integrated units mentioned above can be implemented in the form of hardware or could also be implemented in the form of a software functional unit. In addition, the specific name of each functional unit is only for conveniently mutual distinguishing and is not used to limit the protection scope of the present application. The specific working process of the units in the system mentioned above could make reference to the corresponding process in the above-mentioned method embodiments, and is not described in detail herein.

In the above-mentioned embodiment, the description of each embodiment has its own emphasis, and the parts not described in detail in a certain embodiment could make reference to the relevant descriptions of other embodiments.

Those ordinary skilled in the art would realize that the combination of the units and algorithm steps of each illustration described in the embodiments which is disclosed by the present application, that can be implemented through electronic hardware or the combination of computer software with electronic hardware. Whether the functions are executed by hardware or software depends on the specific application and design constraints of the technical solutions. Those skilled in the art could use different methods to implement the described functions for each particular application, but this implementation should not be considered to be beyond the scope of the present application.

In the embodiments provided by the present application, it should be understood that the server and the methods disclosed by the present application can be achieved in other ways. For example, the server embodiments described above are merely illustrative. For example, the division of the units is only a division of logical functions, and in actual implementation, other ways of division can be introduced. For example, a plurality of units or components can be combined or integrated into another system, or some features can be ignored or not executed. Another point is that mutual coupling or direct coupling or communication connection displayed or discussed herein can be indirect coupling through some interfaces or units, or can be communication connection, and can be in a form of electrical, mechanical or other forms.

The units illustrated as separate components may or may not be physically separated, and the component displayed as a unit may or may not be a physical unit, namely the component can be arranged in one location or distributed to a plurality of network units. The objects of the solutions provided by the embodiments can be achieved by selecting some or all of the units thereof according to actual needs.

In addition, the functional units in each embodiment provided by the present application can be integrated in one processing unit, or each unit can be physically present separately, or two or more than two units can be integrated in one unit. The integrated units mentioned above can be realized in the form of hardware or in the form of a software functional unit.

When the integrated unit is realized in the form of a software functional unit and sold or used as an independent product, the integrated unit can be stored in a computer readable storage medium. Based on the understanding in this way, in the present application, the implementation of all or part of the procedures of the methods provided by the embodiments can be completed through a computer program to instruct related hardware. The computer program can be stored in a computer readable storage medium, and the steps of the above mentioned method embodiments can be implemented when the computer program is executed by a processor. Wherein, the computer program includes computer program codes, and the computer program codes can be in the form of source codes, object codes, an executable file, or some intermediate forms and the like. The computer readable medium comprises: any entity or device capable of carrying the computer program code, a recording medium, a USB flash disk, a mobile hard disk, a magnetic disk, an optical disk, a computer memory, a read-only memory (ROM), a random access memory (RAM), an electric carrier signal, a telecommunication signal, a software distribution medium and the like. It should be noted that the contents stored in the computer readable medium can be properly increased or reduced according to requirements of legislation and patent practices in a judicial management area. For example, according to legislation and patent practices, in some certain judicial management areas, the computer readable medium does not include the electric carrier signal and the telecommunication signal.

The above-mentioned embodiments are only used to illustrate the technical solutions of the present application, and are not intended to limit the present application. Although the present application is described in detail with reference to the embodiments described above, the ordinary skilled in the art should understand that the technical solutions described in the above-mentioned embodiments can still be modified, or part of the technical features thereof can still be equivalently replaced. However said modifications or replacements do not enable the essence of the corresponding technical solutions to be detached from the spirit and scope of the technical solutions of the embodiments provided by the present application. Said modifications or replacements are all included in the protection scope of the present application.

1. A file sharing method based on two-dimensional code, comprising:
obtaining a user mail sent by a user, wherein the user mail contains a mail subject, a user address and a shared file;
storing the shared file and obtaining a storage address;
generating a two-dimensional code corresponding to the storage address; and
returning the two-dimensional code to the user, wherein the two-dimensional code serves as an access entry of the shared file and is used for accessing the shared file by the user.

2. The file sharing method based on two-dimensional code as claimed in claim 1, wherein after receiving the user mail sent by the user, the method further includes:
judging whether the user mail contains a sharing identifier or not;
executing operations of storing the shared file and obtaining the storage address if the user mail contains the sharing identifier;
stopping the execution of subsequent operations if the user mail does not contain the sharing identifier.

3. The file sharing method based on two-dimensional code as claimed in claim 1, wherein the method further includes:
obtaining the access frequency of the storage address;
if the access frequency is less than or equal to a preset access threshold, deleting the storage address and the shared file;
if the access frequency is greater than the access threshold, storing the storage address and the shared file.

4. The file sharing method based on two-dimensional code as claimed in claim 1, wherein the returning the two-dimensional code to the user includes:
generating a shared mail containing the two-dimensional code, wherein the receiver address of the shared mail is configured to be the user address; and
sending the shared mail.

5. The file sharing method based on two-dimensional code as claimed in claim 4, wherein the generating a shared mail containing the two-dimensional code further includes:
obtaining a CC object of the user mail;
adding the CC object of the user mail as a CC object of the shared mail.

6. A server, wherein the server comprising:
an obtaining unit configured for obtaining a user mail sent by a user, wherein the user mail contains a mail object, a user address and a shared file;
a storage unit configured for storing the shared file and obtaining a storage address;
a generation unit configured for generating a two-dimensional code corresponding to the storage address; and
a return unit configured for returning the two-dimensional code to the user, wherein the two-dimensional code serves as an access entry of the shared file and is used for accessing the shared file by the user.

7. The server as claimed in claim 6, wherein the obtaining unit further includes:
a judging unit configured for judging whether the user mail contains a sharing identifier or not;
an execution unit configured for executing operations of storing the shared file and obtaining the storage address, if the user mail contains the sharing identifier; and
a stopping unit configured for stopping the execution of subsequent operations if the user mail does not contain the sharing identifier.

8. The server as claimed in claim 6, wherein the return unit includes:
a mail generating unit configured for generating a shared mail containing the two-dimensional code, wherein the receiver address of the shared mail is configured to be the user address; and
a sending unit configured for sending the shared mail.

9. A terminal device, comprising a processor, a storage, a computer program stored in the storage and capable of running in the processor, wherein the processor implements the steps of the file sharing method as claimed in claim 1 when executing the computer program.

10. A computer readable storage medium, the computer readable storage medium storing a computer program, wherein the computer program implements the steps of the file sharing method as claimed in claim 1 when the computer program is executed by a processor.
